(19) United States
(12) Patent Application Publication
(10) Pub. No.: US 2008/0149748 A1
(43) Pub. Date: Jun. 26, 2008

(54) Auxiliary device wiith multi-direction adjusting function for shredder

(75) Inventor: Tie Chun Wang, SanChung City (TW)

Correspondence Address: BACON & THOMAS, PLLC, 625 SLATERS LANE, FOURTH FLOOR, ALEXANDRIA, VA, 22314, US

(73) Assignee: Michilin Prosperity Co., Ltd., SanChung City (TW)

(21) Appl. No.: 11/797,523

(22) Filed: May 4, 2007

(30) Foreign Application Priority Data
Dec. 21, 2006 (TW) 095222507

(51) Int. Cl. B02C 7/04

(52) U.S. Cl. 241/236

(57) ABSTRACT

An auxiliary device with the multi-direction adjusting function for the shredder is disclosed to adjust the entry angle of the shredder opening and the operation height/direction thereof. The auxiliary device comprises a bottom plate, a frame, a height/direction adjusting device for connecting the bottom plate and the frame, and an opening angle adjusting device disposed in the vicinity of the upper portion of the frame. In practice, the shredder and the trash bin thereof are disposed on the auxiliary device, so that the shredder and the opening angle adjusting device are connected for adjusting to a best entry angle. The height/direction adjusting device can change the distance between the bottom plate and the frame to obtain a best operation height for the shredder.

### BACKGROUND OF THE INVENTION

1. Field of Invention

The invention relates to a shredder and, in particular, to an auxiliary device that enables the shredder to adjust the entry angle of the opening and the operation height/direction of the shredder.

2. Related Art

To prevent such documents as legal files, receipts, invoices, credit card numbers, research reports, or personal financial information (e.g., credit card and phone bills) from being released, it is common to destroy them using a shredder. Therefore, the shredder has become an indispensable device for both business and home applications.

As is well known, the action principle of a shredder for shredding paper is to dispose several cutting blades on two rotary shafts with spacers in between. A motor and a gear box are employed to drive the two parallel rotary shafts that rotate in opposite directions. They provide a shearing force on passing paper to cut it into small stripes. According to the mechanical cutting type, shredders can be classified as stripe-cut shredders and cross-cut shredders. In the former case, the cutting blades are disposed regularly on the rotary shafts and cut the paper along the longitudinal direction into long stripes. Each blade in the latter case has several hook-shaped cutting edges. The blades are disposed in a spiral way on the rotary shafts. In this case, the paper is not only cut along the longitudinal direction into stripes, but also cut in the transverse direction into chips.

In the case of either stripe-cut shredders or cross-cut shredders, they are usually sold with a trash basket or bin for accommodating trash paper. Traditional shredders are often not equipped with the function of adjusting the angle, height, and direction of the opening thereof. Therefore, it is usually inconvenient to use them when they are disposed in a half-open space such as under a desk.

### SUMMARY OF THE INVENTION

An objective of the invention is to provide an auxiliary device with the multi-direction adjusting function that can adjust the entry angle of the shredder opening and the operation height/direction thereof.

To achieve the above objective, the disclosed auxiliary device comprises a bottom plate, a frame, a height/direction adjusting device for connecting the bottom plate and the frame, and an opening angle adjusting device disposed in the vicinity of the upper portion of the frame. In practice, the shredder and the trash bin thereof are disposed on the auxiliary device, so that the shredder and the opening angle adjusting device are connected for adjusting to a best entry angle. The height/direction adjusting device can change the distance between the bottom plate and the frame to obtain a best operation height for the shredder.

### BRIEF DESCRIPTION OF THE DRAWINGS

The invention will become more fully understood from the detailed description given herein below illustration only, and thus is not limitative of the present invention, and wherein:

FIG. 1 is a three-dimensional view of the invention;

FIG. 2 is a schematic view showing how the invention adjusts the height and direction of the shredder;

FIG. 3 is a schematic view showing how the angle of the shredder opening is adjusted according to the invention; and

FIG. 4 is a three-dimensional view of the second embodiment of the invention.

### DETAILED DESCRIPTION OF THE INVENTION

The present invention will be apparent from the following detailed description, which proceeds with reference to the accompanying drawings, wherein the same references relate to the same elements.

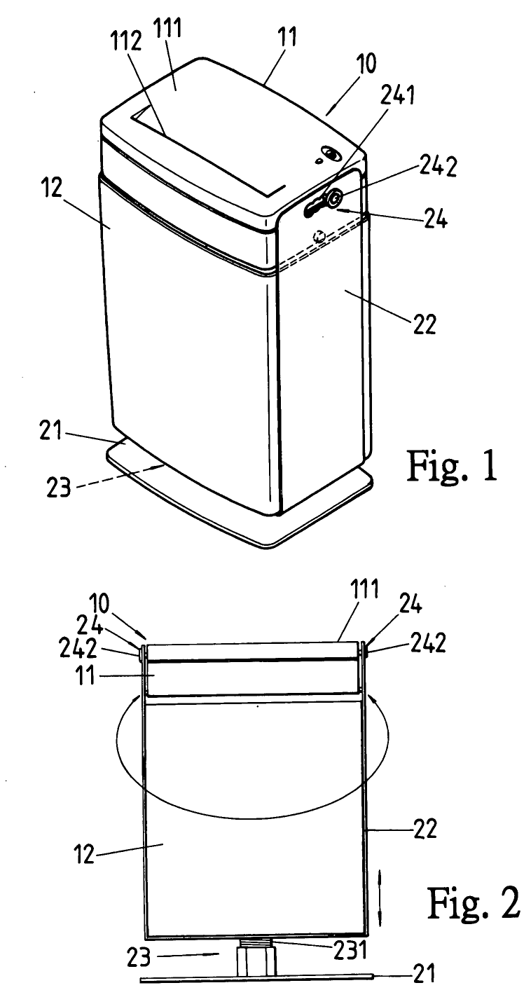

FIG. 1 is a three-dimensional view of the invention. FIG. 2 is a schematic view showing how the invention adjusts the height and direction of the shredder.

As shown in the drawings, the shredder 10 includes a body 11 and a trash bin 12. The body 11 is disposed with traditional blades and motor inside. The panel 111 of the body 11 is also formed with an opening 112 for guiding paper to the blades. The shredder 10 is disposed on an auxiliary device with the multi-direction adjusting function. The auxiliary device includes a bottom plate 21, a frame 22, a height/direction adjusting device 23, and an entry angle adjusting device 24.

The height/direction adjusting device 23 is disposed between the bottom plate 21 and the frame 22. An explicit example is shown in FIG. 2. A screw rod 231 fixed at the center of the bottom plate 21 is provided to rotate the frame 22 with the use of a set of threads, thereby adjusting the distance between the frame 22 and the bottom plate 21 and thus the height of the shredder 10. At the same time, the user can select a best orientation to operate the shredder.

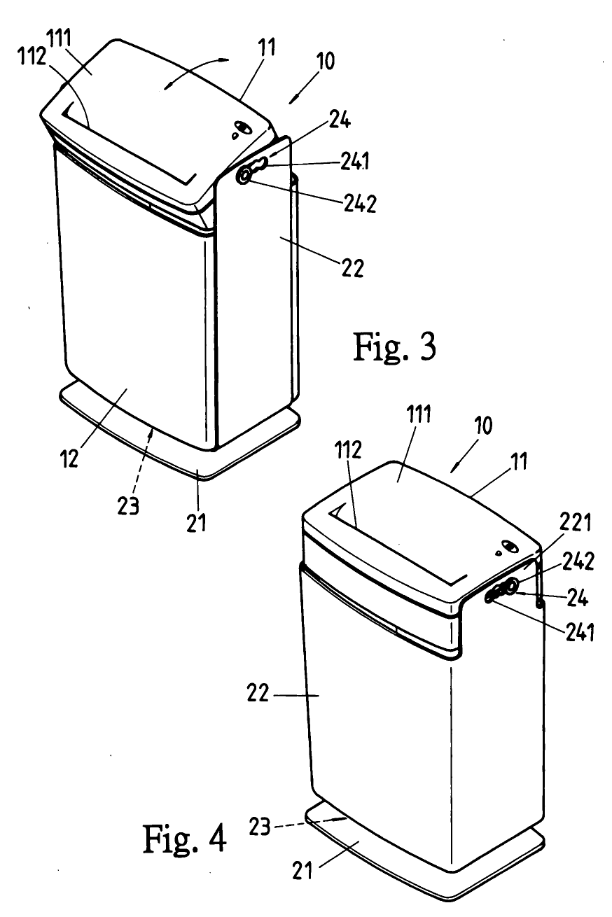

As shown in FIG. 3, the entry angle adjusting device 24 is disposed in the vicinity of the upper portion of the frame 22. It includes an arc positioning cavity 241 and a positioning button 242 across the positioning cavity 241. By adjusting the position of the positioning button 242 in the positioning cavity 241, the entry angle of the opening 112 of the shredder 10 can be changed. Therefore, the user can send in paper at a most convenient angle into the opening 112.

FIG. 4 shows another embodiment of the invention. The frame 22 which also serves as a trash bin is combined with the bottom plate 21 via the height/direction adjusting device 23. The distance between the frame and the bottom plate 21 is adjusted by rotating the frame 22, thereby adjusting the height of the shredder 10. The angle adjusting device 24 disposed on a supporting board 221 in the upper portion of the frame 22 also includes the arc positioning cavity 241 and the positioning button 242 across the positioning cavity 241. By adjusting the position of the positioning button 242 in the positioning cavity 241, the entry angle of the opening 112 of the shredder 10 can be changed. Therefore, the user can send in paper at a most convenient angle into the opening 112.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A shredder with a multi-direction adjusting function, comprising:
a shredder, which includes a body and a trash bin, wherein the body is disposed with cutting blades and motor therein and a panel with an opening for guiding paper to the cutting blades;
an auxiliary device, which is used to support the shredder and to adjust the paper entry angle, height, and direction thereof.

2. The shredder with a multi-direction adjusting function of claim 1, wherein the auxiliary device includes a bottom plate, a frame, a height/direction adjusting device, and an entry angle adjusting device.

3. The shredder with a multi-direction adjusting function of claim 2, wherein the height/direction adjusting device is disposed between the bottom plate and the frame and is used to adjust the distance between them by rotating the frame using a screw rod fixed at the center of the bottom plate and connected to the frame with a set of threads.

4. The shredder with a multi-direction adjusting function of claim 2, wherein the entry angle adjusting device is disposed in the upper portion of the frame and includes a positioning cavity and a positioning button across the positioning cavity, and the paper entry angle is adjusted by changing the position of the positioning button in the positioning cavity.

5. A shredder with a multi-direction adjusting function, comprising:
a shredder, which includes a body and a frame that also serves as a trash bin, wherein the body is disposed with cutting blades and motor therein and a panel with an opening for guiding paper to the cutting blades;
an auxiliary device, which is used to adjust the paper entry angle, height, and direction of the shredder.

6. The shredder with a multi-direction adjusting function of claim 5, wherein the auxiliary device includes a bottom plate, a frame, a height/direction adjusting device, and an entry angle adjusting device.

7. The shredder with a multi-direction adjusting function of claim 6, wherein the height/direction adjusting device is disposed between the bottom plate and the frame and is used to adjust the distance between them by rotating the frame using a screw rod fixed at the center of the bottom plate and connected to the frame with a set of threads.

8. The shredder with a multi-direction adjusting function of claim 6, wherein the entry angle adjusting device is disposed in the upper portion of the frame and includes a positioning cavity and a positioning button across the positioning cavity, and the paper entry angle is adjusted by changing the position of the positioning button in the positioning cavity.
